(19) United States
(12) Patent Application Publication
(10) Pub. No.: US 2016/0311298 A1
(43) Pub. Date: Oct. 27, 2016

(54) Method and Apparatus for car Cover and Protection

(71) Applicant: Mahmood Rouf Tokhy, Fremont, CA (US)

(72) Inventor: Mahmood Rouf Tokhy, Fremont, CA (US)

(21) Appl. No.: 14/697,171

(22) Filed: Apr. 27, 2015

(51) Int. Cl. B60J 11/02; B60R 16/023; B60J 11/04

(52) U.S. Cl. CPC B60J 11/02; B60J 11/04; B60R 16/023

(57) ABSTRACT

A new car cover and protection apparatus where the protective material houses in dual cylindrical units deployed on top of the roof of an automobile. The dual housing of the rollers and protective materials makes the deployment and disengagement manageable and in quick time. Through a motor and electronics, the engagement and disengagement is integrated to remote control and control over the local and wide area network.

### FIELD OF THE INVENTION

The present invention relates generally to automobile covers. More specifically, a new retractable car cover and protection device and method is proposed based on dual housing of the retractable protection material. The apparatus when installed and deployed on an automobile provides cover and protection to the car with added benefits of quick deployment and disengagement. Such advantages make possible the use of such devices in crowed and space restrictive areas of parking.

### BACKGROUND OF THE INVENTION

Next to a person's home and place of work, an automobile is the place where a person spends a major amount of time. The automobile essentially follows the person at his home, at his place of work and to all places where a person wishes to go. Automobiles, similar to other devises and systems are going through generational upgrades through technology and innovation. A typical automobile is now equipped with several display devices, audio systems, video systems and internet connection to the cloud. Automobiles are now available which provide local WIFI internet connection, front and rear cameras, voice based activation, automatic driving and onboard diagnostics.

These complex electronic and electro-mechanical systems deployed in an automobile make it an attractive target for vandalism and theft. Automobile is almost always parked in the outdoors on the street of towns and cities, in the drive way or at parking stations with public access. The outdoor locations for an automobile subject it to various hazards. It may be hit with missiles and projectiles comprising of small to big metal pieces, gravel and rock. While some of such projectiles and missiles may be through intentional conduct, often the mere outdoor location of an automobile may subject it to them by accident or incident of other moving cards, debris on the road etc. Without a cover for the car, such deliberate or accidental incidents lead to damage to the cards, leading to costly repair, downtime and disruption of life of the owner. Therefore, present outdoor hazards present a convincing case that automobiles parked in the outdoors require a cover for protection.

There are other reasons for the use of car cover. While parked in the outdoors, the automobile is subjected to natural hazards. The sunlight projecting on the automobile warms and heats up the fully locked car in the inside, raising temperatures to dangerous levels. Equipment inside the car compartment as well as the rest of the apparatus is subjected to intense heat for several hours. The subjection to heat and high temperature inside the car reduces the life time of all costly durables, seats, dashboard along with the electronics. Similarly, when parked outside, the automobile is subjected to dust, rain and wind. Rain, wind and dust affect the outside polish, appearance and have tendency to erode paint, protective materials, subjecting to scratches, rust and dents. This leads to constant need for car washing, further exposing the automobile to water and chemicals. These issues can be appropriately handled by keeping the car covered when it is parked for long or short duration.

The current at for car covers is inadequate due to several reasons. Existing solutions are available where a fabric like material covers the car while also touching its body. Deployment of such covers requires more than one person, is cumbersome and time consuming. Each time, the car cover has to be unfolded, placed on the car, removed and folded again before being placed in the car. Such deployment is not possible in busy city streets. Some retractable car cover solutions are available to overcome some deficiencies, but fall short. Most solutions have one point housing and rolling system which is hard and time consuming to deploy. Some solutions place a permanent cylindrical housing close to the rear bumper. Other solutions require fixtures in the front and side of the car to deploy the car cover. These mechanisms are not practical for quick deployment and disengagement often required on busy city streets where damages due to hazards are more probable.

The present invention overcomes these shortcomings in the art by proposing a dual housing unit for protective material to be placed on top of the automobile. The dual housing leads to easy deployment and disengagement, possibility of only one half deployment, either front or back. The deployment of cover and its disengagement can be automatic through use of motors in each housing unit and integrated to car electronics for remote and networked control.

### BRIEF DESCRIPTION OF THE DRAWINGS

FIG. 1 is one embodiment showing the apparatus of the present invention. It has two cylindrical housing units comprising of rolled protection material and each housing unit comprising plastic or wooden roller embedded in the cylindrical housing unit.

FIG. 2 is one embodiment of the apparatus as deployed on an automobile through permanent or temporary attachments to the automobile top roof, with protection cover material extending from each cylindrical housing unit and covering the automobile.

FIG. 3 is one embodiment of the apparatus as seen from the top, showing the rollers embedded within two cylindrical housing units.

FIG. 4 is one embodiment illustrating the side view of the apparatus as it will be installed on top of an automobile with the protection material completely rolled in on the rollers embedded within two cylindrical housing units.

FIG. 5 is one embodiment illustrating the side view of the apparatus deployed on top of an automobile where the protection cover is fully deployed and covering the automobile in the front and the back.

### DETAIL DESCRIPTIONS OF THE INVENTION

All illustrations of the drawings are for the purpose of describing selected versions of the present invention and are not intended to limit the scope of the present invention.

In the following description specific details are set forth describing certain embodiments. It will be apparent, however, to one skilled in the art that the disclosed embodiments may be practiced without some or these entire specific details. The specific embodiments presented are meant to be illustrative, but not limiting. One skilled in the art may realize other material that, although not specifically described herein, is within the scope and spirit of this disclosure.

The present invention is targeted towards automobiles. To overcome the shortcomings of the present art, a dual housed car cover apparatus is proposed which is retractable. Two cylindrical housing units are chosen. Each unit comprises of a roller apparatus made out of plastic or wood as a rod. Through proper attachments, in one embodiment, protective material is hard attached to the rolling rod on one end and the protective material is rolled along the rod to be packed and contained around the rolling rod. The protective material in one embodiment has mechanisms of spring action and lock, so that where the protective material is stretched, it rolls out and stays rolled, forming a cover. It can them be either left in that position to be rolled back manually through a handle or through a motor mechanism. In one embodiment, the protective material is rainproof thin material. In another embodiment, the material is thin shade for the sun protection. In another embodiment, the protective material is structurally supported by underlying metal structure pivoted at cylindrical housings to withstand substantial torque and weight. In this embodiment, the protective material prevents all hazards away from the car. Where the protective material is light and does not have support metallic structure, the protective material after deployment is attached to the car through elastic tie-ins with hooks on either side. One end of the elastic tie-in attaches to the protective material whereas the other attaches to available hooks under the bumper of the car on each side. In this embodiment, through appropriate magnetic cylindrical thin blocks, a safe distance can be maintained between the protective material and the automobile to be able to withstand rock and metal missiles while parked and thereby protecting the car. In one embodiment, two elastic tie-ins are used, one on each side of the car. In one embodiment, plurality of cylindrical blocks is used.

In one embodiment, the dual cylindrical housing apparatus attaches to the automobile through a plurality of support attachments. In one embodiment, the support attachments are directly connected to the upper roof body of the automobile through screw and nut mechanisms. In another embodiment, the attachments are held in place through cup suctions and tied to the car body through rope tie-ins. In another embodiment, the attachments ate held to the surface of the car through ultra-strong magnets capable of withholding strong wind pressures and secondarily tied to the body of the car.

In one embodiment, the apparatus is permanently attached to the roof of the car. In another embodiment, the apparatus may be attached to a preexisting carrier or stand available in a number of vehicles. In such an embodiment, instead of attaching to the roof of the car, the apparatus would attach to the existing stand or carrier. In one embodiment, a mechanism to cover the automobile from the top is presented. In another embodiment, in addition, similar mechanism may be deployed to cover the side of the automobile.

In one embodiment, the plastic or wooden roller over which the protective material is wrapped is moved through a manual handle attached to it on one side. In one embodiment, the handle moves in both directions to deploy or disengage the protective material. In the other embodiment, the deployment happens merely by pulling out the protective material from grooves available in each of the two cylindrical housings. The disengagement in this embodiment occurs either through a handle or by triggering a rollback through a push in the direction of the cylindrical housing.

In one embodiment, both engagement and disengagement of the protective materials housed in the cylindrical units are controlled by electronic controlled motors which are connected to the electrical system of the automobile. In addition, they are operable through remote control for short distances and through the internet cloud over LAN or WAN for longer distances. With a connected car, and based on weather reports, traffic reports, a driver may remotely engage or disengage the retractable covers while in home or from workplace. The driver is relieved of performing the tedious tasks to walk to the automobile and engage the covers particularly during inclement weather.

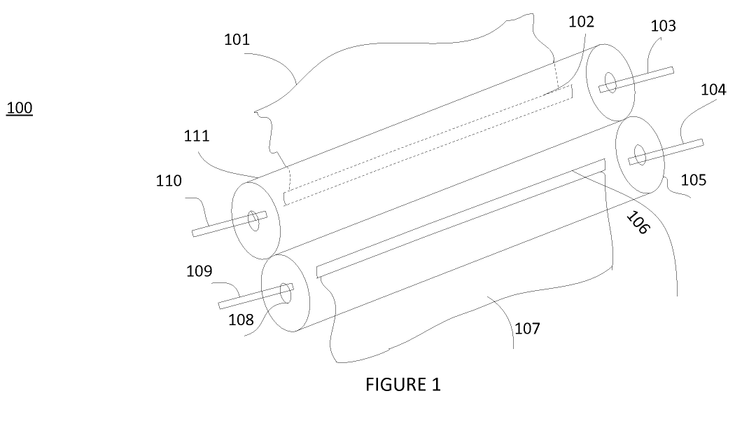

FIG. 1 100 is an exemplary embodiment of the apparatus of present invention. The two cylindrical housings 105 111 have a roller block 103 104 110 109 each. In one embodiment the roller block is made of plastic, In another embodiment, it may be made of wood or any other material. Each of the cylindrical housings 111 105 have horizontal grove 102 106 along the length and of width suitable for the protective material 101 107 to easily engage and disengage. Each of the cylindrical housings has a circular cap on each side with small circular hole 108 for the roller 109 110. The apparatus is exemplified in an isometric view. The apparatus is attached to the top of an automobile through plurality of mechanisms. Rollers 110 109 103 104 may be attached to handle on one or both ends. In another embodiment, rollers 110 109 108 104 may be operated through a motor or two motors one on each side. The motor may be connected to automobile electronics for remote and networked control.

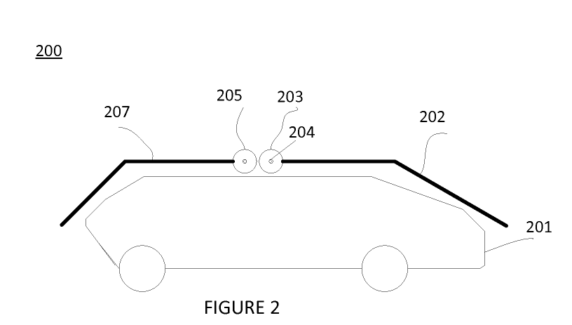

FIG. 2 200 illustrates the apparatus in a side view, engaged and deployed on an automobile 201. The two cylindrical housing units 203 205 have rollers 204. The protective material 202 207 is shown protruding from the cylindrical housings 203 205. The protective material 202 207 may have metallic retractable frames to hold itself, pivoting from the housing unit in one embodiment. In another embodiment, the protective materials 202 207 may be attached to the front and back bumper through elastic tie-ins. The cylindrical housings are attached to the top of an automobile.

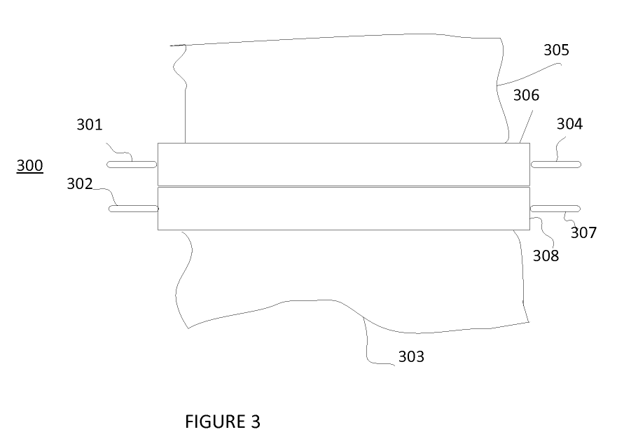

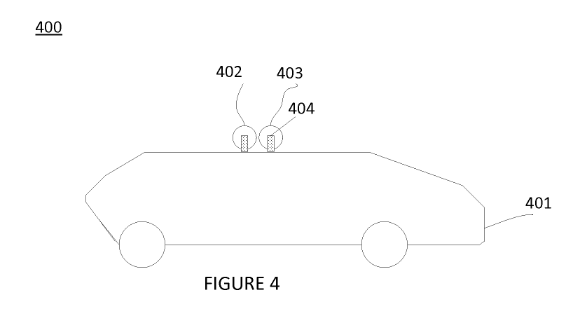

FIG. 3 300 illustrates a top view of the apparatus as it will be installed on the roof of an automobile. The cylindrical housing units 306 308 comprise of rollers 301 302 304 307 over which the protective cover material 305 303 is wrapped and rolled. The protective material can be engaged and disengaged through mechanisms of a motor, manually. The protective material may itself have metallic structures to support a frame and bend angles to follow the contours of the car. When deployed, the protective material covers the car and protects it from natural as well as artificial hazards. Support of engagement and disengagement is manual or through automated motors under car electronic control remotely as well over the network. FIG. 4 400 illustrates a side view of the apparatus as installed on an automobile 400. The protective material in each of the cylindrical houses 402 403 is fully wrapped and rolled inside through the grooves in each. The apparatus is attached to the car through properly shaped metallic or plastic blocks 404. When fully rolled, the protective cover presents minimal overhead. The center on car location and two cylindrical housing units makes the engagement and disengagement easy, manipulating in minimal spacing around the car and in minimal time. No extra storage inside the car is required. The circular shapes of the cylindrical housing units reduce the drag on the car during driving.

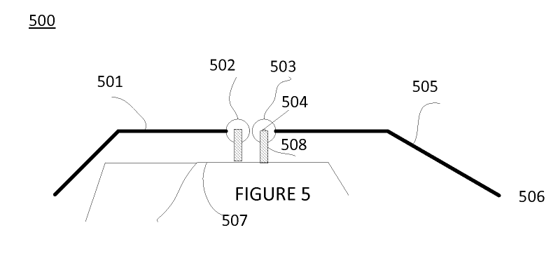

FIG. 5 500 illustrates a side view of the apparatus as deployed and engaged. The top of the automobile 507 is attached to the apparatus using rectangular or other shaped blocks 508. The cylindrical housing units 502 nd 503 have rollers 504. Using either mechanized motor or through manual handle or pulling, the protective material is deployed. In one embodiment, through the metallic frame and bend mechanisms, the protective material 501 505 follows the contours of the car in order to shield, cover and protect the automobile.

While this exemplary embodiment is for an automobile, the invention equally applies to all movable things including cars, trucks, recreational vehicles and airplanes.

Although the present invention has been explained in relation to its preferred embodiment, it is to be understood that many other possible modifications and variations can be made without departing from the spirit and scope of the invention as herein claimed.

Consequently, embodiments as described herein may provide an integrated car cover and protection mechanism that is able to engage and disengage quickly and with use of limited space around the car when parked. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. An automobile cover and protection device, comprising:
a first cylindrical housing unit and;
a first roller rod housed with an attached protective material;
a second cylindrical housing unit and;
a second roller rod housed with an attached protective material and;
a mutual coupling of the two housing units and onto an automobile and;
an engagement and disengagement apparatus for a protective material to cover and protect an automobile.

2. The automobile cover and protection device of claim 1 attached to the automobile using attach blocks, screws and nuts.

3. The automobile cover and protection device of claim 1 attached to the automobile using at least one of strong magnetic attachment and cup suction.

4. The automobile cover and protection device of claim 1 where the engagement and disengagement apparatus comprises of use of a manual handle.

5. The automobile cover and protection device of claim 1 where the engagement and disengagement apparatus comprises of use of an electronic motor.

6. The automobile cover and protection device of claim 1 where the engagement and disengagement apparatus is controlled through at least one of remote key control or networked control.

7. An automobile cover and protection method, comprising:
a first cylindrical housing unit and;
a first roller rod housed with an attached protective material;
a second cylindrical housing unit and;
a second roller rod housed with an attached protective material and;
a mutual coupling of the two housing units and onto an automobile and;
an engagement and disengagement mechanism for a protective material to cover and protect an automobile.

8. The automobile cover and protection method of claim 7 where the engagement and disengagement apparatus comprises of use of a manual handle.

9. The automobile cover and protection method of claim 7 where the engagement and disengagement apparatus comprises of use of an electronic motor.

10. The automobile cover and protection method of claim 7 where the engagement and disengagement apparatus is controlled through at least one of remote key control or networked control.
